(19) United States
(12) Patent Application Publication
(10) Pub. No.: US 2012/0199514 A1
(43) Pub. Date: Aug. 9, 2012

(54) Broken compact fluorescent lamp collection and storage system

(76) Inventors: Joseph C. Schengrund, II, Jackson, NJ (US); Joseph C Schengrund, III, Jackson, NJ (US)

(21) Appl. No.: 13/066,130

(22) Filed: Apr. 7, 2011

Related U.S. Application Data
(60) Provisional application No. 61/462,389, filed on Feb. 3, 2011.

(51) Int. Cl. B65D 85/00; B25J 1/04

(52) U.S. Cl. 206/524.1; 294/209

(57) ABSTRACT

A broken compact fluorescent lamp collection and storage system utilizes a reuseable glass fragment, debris, and mercury residue collector having a handle and a frame within which a disposable roller element with an adhesive surface is mounted. Glass fragments, debris and mercury residue are collected on the adhesive surface on the roller element, which is removed from the frame after use. A fresh, replacement roller element is then inserted into the frame. The system also includes an airtight enclosure into which the dirty removeable roller element is placed for ultimate transport and disposal.

### RELATED APPLICATION

This application claims the benefit of provisional application Ser. No. 61/462,389 filed on Feb. 3, 2011.

### BACKGROUND OF THE INVENTION

Although energy efficient, the new compact fluorescent lamps widely in use today can be environmentally unsafe, since many of these lamps contain hazardous substances, such as mercury vapor, powdered chemical debris, and specially treated glass. Thus, breakage of the bulbs of compact fluorescent lamps break could present a danger to individuals charged with cleaning and collection of the remnants of the breakage, e.g. glass fragments, powdered chemical, mercury residue, etc. Appropriate collection devices and protective storage containers for housing such potentially hazardous material are necessary to ensure for human safety. Vacuuming or sweeping glass fragments of bulbs from broken compact fluorescent lamps will cause settled mercury particles from the bulb to become airborne. Mercury vapor is harmful to humans, and especially children. As a result, there is currently no effective collection system for retrieving debris from broken compact fluorescent lamps and no storage system to safely contain this debris for transport and eventual disposal.

### SUMMARY OF THE INVENTION

It is therefore the object of the present invention to provide a broken compact fluorescent lamp collection and storage system which results in the effective and efficient collection of glass fragments and other debris and residue from a broken bulb from a compact fluorescent lamp and the safe storage of these fragments, debris and residue for transport and disposal.

It is the object of the present invention to provide a broken compact fluorescent lamp collection and storage system which utilizes a reuseable glass fragment and debris collector comprising a roller element with an adhesive surface to retrieve glass fragments, debris and residue, and an air-tight enclosure specifically configured to store the contaminated roller element for transport and appropriate disposal.

It is a further object of the present invention to provide a broken compact fluorescent lamp collection and storage system which traps and retrieves mercury particles with minimal agitation and prevents the particles from being redistributed into the atmosphere.

These and other objects are accomplished by the present invention, a broken compact fluorescent lamp collection and storage system which utilizes a reuseable glass fragment, mercury residue and debris collector having a handle and a frame within which a disposable roller element with an adhesive surface is mounted. Glass fragments, debris and mercury residue are collected on the adhesive surface on the roller element, which is removed from the frame after use. A fresh, replacement roller element is then inserted into the frame. The system also includes an airtight enclosure into which the dirty removeable roller element is placed for ultimate transport and disposal.

The novel features which are considered as characteristic of the invention are set forth in particular in the appended claims. The invention, itself, however, both as to its design, construction and use, together with additional features and advantages thereof, are best understood upon review of the following detailed description with reference to the accompanying drawings.

### BRIEF DESCRIPTION OF THE DRAWINGS

FIG. 1 shows an elevation view of the glass fragment and debris collector of the present invention.

FIG. 2 is an elevation view of the glass fragment and debris collector of the present invention with its roller element detached.

FIG. 3 is a top view of the glass fragment and debris collector of the present invention with its roller element attached.

FIG. 4 shows the roller element with retrieved glass fragment, mercury residue and debris stored in the airtight enclosure of the present invention.

### DETAILED DESCRIPTION OF THE INVENTION

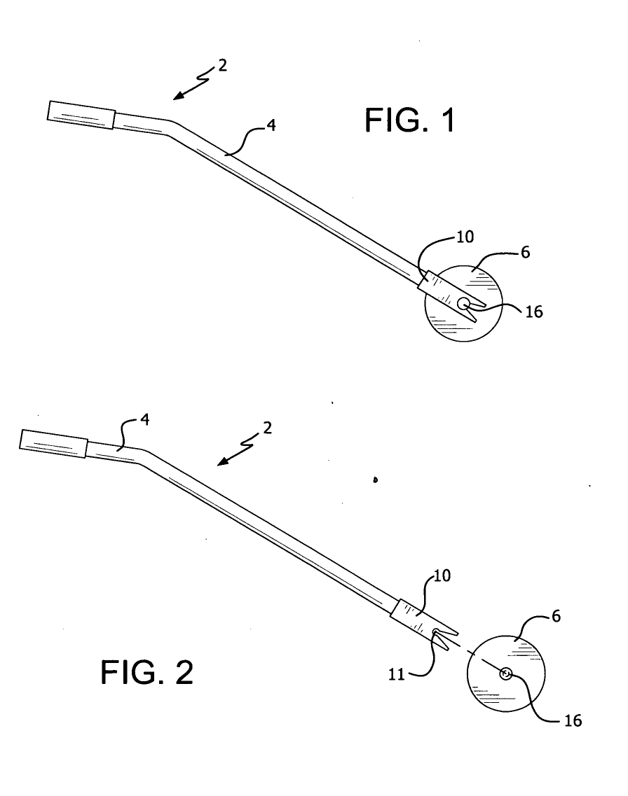

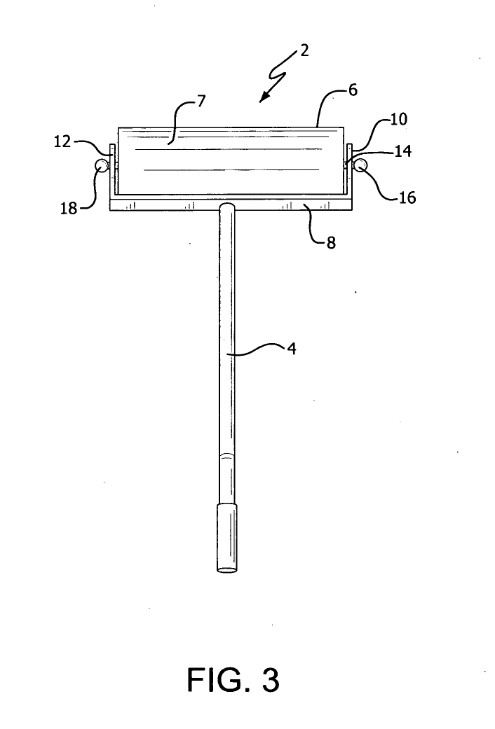

The broken compact fluorescent lamp collection and storage system of the present invention comprises glass fragment and debris collector 2 and airtight enclosure 20. Collector 2 comprises handle 4 extending from frame 8 having lateral support arms 10 and 12. Roller element 6 comprises support spindle 14 which extends through the roller element. Spindle 14 comprises end tabs 16 and 18. As seen in FIGS. 1-3, spindle 14 is configured to be inserted into slot 11 of support arm 10 and an identical slot (not shown) in support arm 12, in order to secure roller element 6 within frame 8. End tabs 16 and 18 serve to maintain roller element 6 between support arms 10 and 12. However, roller element 6 is readily removeable from frame 8, simply by pulling the roller element out from support arms 10 and 12.

Roller element 6 has an outer adhesive surface 7 capable of attaching and adhering to glass fragments 26 and powdery substances, mercury residue, and other debris 28 which would result from the breakage of the broken bulb from a compact fluorescent lamp. By running adhesive roller 2 manually over the surface areas containing the remnants of the breakage, broken glass fragments, mercury residue and other debris will be picked up by roller element 6. The dirty, contaminated roller element 6 can then easily be detached from frame 8.

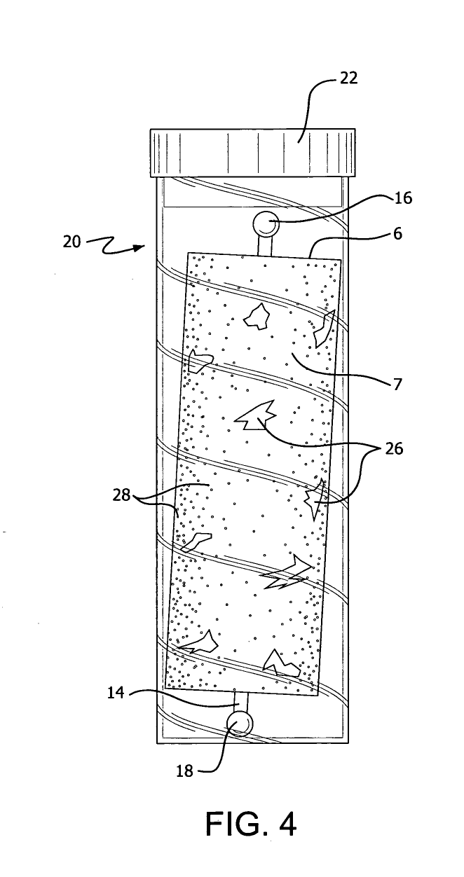

FIG. 4 shows airtight enclosure 20 with threaded lid 22. Roller element 6, having been utilized to collect glass fragments 26, powdered substances, mercury residue and other debris 28 from the broken bulb of a compact fluorescent lamp, and then removed from frame 8 of collector 2, is immediately placed within enclosure 20 and sealed therein by lid 22. A clean, fresh replacement roller element can then be inserted between support arms 10 and 12 within frame 8 of collector 2, which permits the continued use of the collector.

In this manner, collector 2 and its removeable roller element 6, is simply and safely utilized to retrieve glass fragments, airborne mercury residue, and debris due to the breakage of the bulb of compact fluorescent lamp, from a variety of surfaces, including carpeting, hardwood floors, tile, countertops, furniture, clothing, etc. In addition, both collector 2 and container 20 can be manufactured in different sizes to allow for ease and versatility in decontaminating these surfaces.

Certain novel features and components of this invention are disclosed in detail in order to make the invention clear in at least one form thereof. However, it is to be clearly understood that the invention as disclosed is not necessarily limited to the exact form and details as disclosed, since it is apparent that various modifications and changes may be made without departing from the spirit of the invention.

1. A broken compact fluorescent lamp collection and storage system comprising:
a glass fragment, mercury residue and debris collector comprising a handle and a frame within which a roller element with an adhesive surface is mounted, and means removeably securing the roller element within the frame, whereby upon running the roller element over glass fragments, mercury residue and debris from a broken bulb of a compact fluorescent lamp, the glass fragments, mercury residue and debris are adhered to and collected on the adhesive surface of the roller element; and
an airtight enclosure sized to contain the roller element, and means to seal the enclosure, whereby the roller element, with glass fragments, mercury residue and debris adhere thereto, is placed in and sealed within the enclosure to permit the safe storage and transportation of the glass fragments, mercury residue and debris.

2. The broken compact fluorescent lamp collection and storage system as in claim 1 wherein the means removeably securing the roller element comprises slots within support arms extending from the frame.

3. The broken compact fluorescent lamp collection and storage system as in claim 1 wherein the means removeably securing the roller element is configured to permit a roller element with glass fragments, mercury residue and debris adhered thereto to be replaced by a clean, fresh roller element.
